(19) United States
(12) Patent Application Publication
(10) Pub. No.: US 2018/0134120 A1
(43) Pub. Date: May 17, 2018

(54) VEHICLE HVAC SYSTEM

(71) Applicants: Calin Marginean, Lake Orion, MI (US); Murali Govindarajalu, West Bloomfield, MI (US)

(72) Inventors: Calin Marginean, Lake Orion, MI (US); Murali Govindarajalu, West Bloomfield, MI (US)

(21) Appl. No.: 15/352,727

(22) Filed: Nov. 16, 2016

(51) Int. Cl. B60H 1/24; B60H 1/00; B60H 1/34

(52) U.S. Cl. CPC B60H 1/242; B60H 1/00678; B60H 1/34; B60H 1/00564

(57) ABSTRACT

A vehicle includes an HVAC system having a duct assembly and a panel. The duct assembly includes an inlet passage and a manifold. The manifold includes a uniform outlet airflow path, a direct outlet airflow path, and a valve member. The valve member is movable between an open position allowing air to flow from the inlet passage to the uniform outlet airflow path and a closed position allowing air to flow from the inlet passage to the direct outlet airflow path and restricting air from flowing from the inlet passage to the uniform outlet airflow path. The panel includes a diffuse-flow aperture and a concentrated-flow aperture. The diffuse-flow aperture is fluidly connected to the uniform outlet airflow path and is fluidly isolated from the direct outlet airflow path. The concentrated-flow aperture is fluidly connected to the direct outlet airflow path and is fluidly isolated from the uniform outlet airflow path.

### FIELD

The present disclosure relates a vehicle HVAC system.

### BACKGROUND

Conventional vehicles include an HVAC (heating, ventilation, and air conditioning) system that provides airflow to assumed leg positions in a foot well of an occupant cabin so that the legs of an occupant (e.g., a driver or passenger) within the foot well can be heated or cooled, for example. Once the passenger's comfort level is achieved, the airflow to the foot well is decreased (either automatically by the HVAC system or manually by the occupant) to avoid overheating the occupant's feet and/or legs. The decrease in airflow to the foot well often causes the temperature of air in the foot well to drop (i.e., during cold weather conditions) relative to the temperature of the air in the rest of the occupant cabin. The vehicle HVAC system of the present disclosure maintains a comfortable temperature of the air within the foot well without overheating the occupant's feet and/or legs.

### SUMMARY

This section provides a general summary of the disclosure, and is not a comprehensive disclosure of its full scope or all of its features.

In one form, a vehicle HVAC system delivers airflow to a vehicle occupant cabin. The vehicle HVAC system includes a duct assembly and a panel. The duct assembly includes an inlet passage and a manifold. The manifold receives airflow from the inlet passage and includes a uniform outlet airflow path, a direct outlet airflow path, and a valve member. The valve member movable between an open position allowing air to flow from the inlet passage to the uniform outlet air flow path and a closed position allowing air to flow from the inlet passage to the direct outlet airflow path and restricting air from flowing from the inlet passage to the uniform outlet air flow path. The panel is disposed in the vehicle occupant cabin and includes a diffuse-flow aperture that is open to the occupant cabin and a concentrated-flow aperture that is open to the occupant cabin. The diffuse-flow aperture is fluidly connected to the uniform outlet airflow path and is fluidly isolated from the direct outlet airflow path. The concentrated-flow aperture is fluidly connected to the direct outlet airflow path and is fluidly isolated from the uniform outlet airflow path.

In some configurations, the valve member allows air to flow from the inlet passage to the direct outlet airflow path when the valve member is in the open position.

In some configurations, a spring is attached to the valve member and biases the valve member toward the open position.

In some configurations, the duct assembly includes a partition that separates the uniform outlet airflow path and the direct outlet airflow path.

In some configurations, the valve member is angled relative to the inlet passage such that air flowing through the inlet passage biases the valve member toward the closed position.

In some configurations, a fan is disposed upstream of the manifold and forcing air through the inlet passage, the fan operable at a low speed and at a high speed, wherein the air flowing through the inlet passage when the fan is operating at the low speed exerts a lesser force on the valve member than a force that the spring exerts on the valve member biasing the valve member toward the open position, and wherein the air flowing through inlet passage when the fan is operating at the high speed exerts a greater force on the valve member biasing the valve member toward the closed position than the force that the spring exerts on the valve member biasing the valve member toward the open position.

In some configurations, the valve member is pivotably mounted to the inlet passage of the duct assembly.

In some configurations, a thermal spring is coupled to the valve member such that the valve member is moved to the closed position when a temperature of the airflow passing through the inlet passage exceeds a predetermined threshold value and the valve member is moved to the open position when the temperature of the airflow passing through the inlet passage is below the predetermined threshold value.

In some configurations, wherein the manifold includes a plurality of uniform outlet openings and a plurality of direct outlet openings, wherein air flowing though the uniform outlet airflow path exits the manifold through the uniform outlet openings, and wherein air flowing through the direct outlet airflow path exits the manifold through the direct outlet openings.

In some configurations, the panel includes a plurality of diffuse-flow apertures and a plurality of concentrated-flow apertures.

In some configurations, the vehicle HVAC system further comprises a plurality of conduits connecting the manifold to the panel, wherein the each of the uniform outlet openings is fluidly coupled with a corresponding one of the diffuse-flow apertures by a corresponding one of the plurality of conduits, and wherein the each of the direct outlet openings is fluidly coupled with a corresponding one of the concentrated-flow apertures by a corresponding one of the plurality of conduits.

In some configurations, the panel includes more diffuse-flow apertures than concentrated-flow apertures.

In some configurations, the panel is disposed at a foot well within the occupant cabin, wherein the diffuse-flow aperture directs airflow into the foot well, and wherein the concentrated-flow aperture directs airflow into the foot well.

In some configurations, the vehicle HVAC system further includes a heating element disposed upstream of the manifold and in a heat transfer relationship with airflow upstream of the manifold.

In some configurations, the vehicle HVAC system further includes a cooling element disposed upstream of the manifold and in a heat transfer relationship with airflow upstream of the manifold.

Further areas of applicability of the teachings of the present disclosure will become apparent from the detailed description, claims and the drawings provided hereinafter, wherein like reference numerals refer to like features throughout the several views of the drawings. It should be understood that the detailed description, including disclosed embodiments and drawings referenced therein, are merely exemplary in nature intended for purposes of illustration only and are not intended to limit the scope of the present disclosure, its application or uses. Thus, variations that do not depart from the gist of the present disclosure are intended to be within the scope of the present disclosure.

### BRIEF DESCRIPTION OF THE DRAWINGS

The drawings described herein are for illustrative purposes only of selected embodiments and not of all possible implementations, and are not intended to limit the scope of the present disclosure.

FIG. 1 is a side view of a vehicle with an HVAC system fluidly coupled to a foot well of an occupant cabin according to the principles of the present disclosure;

FIG. 2 is a perspective view of a distribution duct of the HVAC system of FIG. 1;

FIG. 3 is a cross-sectional view of the distribution duct taken along line 3-3 of FIG. 2 and depicts the distribution duct in a diffuse state;

FIG. 4 is a cross-sectional view of the foot well of FIG. 1 while the distribution duct is in the diffuse state;

FIG. 5 is a cross-sectional view of the distribution duct taken along line 3-3 of FIG. 2 and depicts the distribution ducts in a concentrated state;

FIG. 6 is a cross-sectional view of the foot well of FIG. 1 while the distribution duct is in the concentrated state; and

FIG. 7 is a cross-sectional view of another configuration of the distribution duct.

Corresponding reference numerals indicate corresponding parts throughout the several views of the drawings.

### DETAILED DESCRIPTION

Example embodiments will now be described more fully with reference to the accompanying drawings.

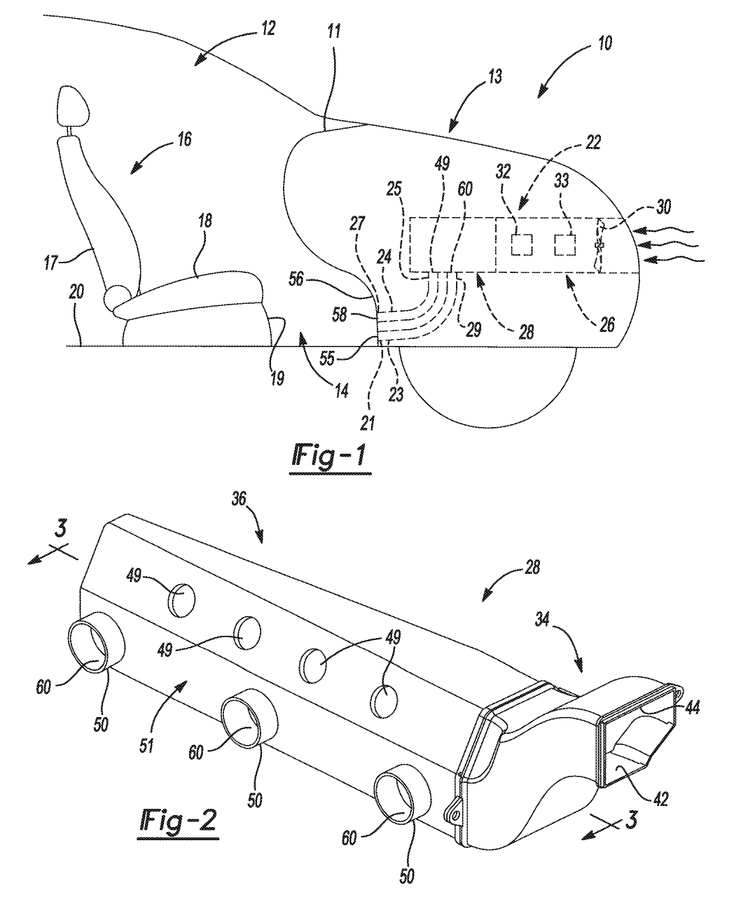

FIG. 1 depicts a vehicle 10 having a panel member 11 that separates an occupant cabin 12 and a front portion 13 of the vehicle 10. The occupant cabin 12 includes a foot well 14 defined by the panel member 11. A vehicle seat assembly 16 is positioned within the occupant cabin 12 to seat an occupant (e.g., a driver or passenger; not shown). The vehicle seat assembly 16 includes a seatback 17 attached to a seat bottom 18. The seat bottom 18 is attached to a support member 19 coupled to a vehicle floor 20 such that the seat bottom 18 and the support member 19 are adjacent to the foot well 14.

An HVAC (heating, ventilation, and air conditioning) system 22 is disposed within the front portion 13 of the vehicle 10. The HVAC system 22 is fluidly coupled to the foot well 14 to provide a flow of heated or cooled air to the foot well 14 via one or more concentrated duct lines 23 and one or more uniform duct lines 24. As will be described in more detail below, the HVAC system 22 is operable between a concentrated state in which the HVAC system 22 permits airflow to the foot well 14 of the occupant cabin 12 via the concentrated duct lines 23 and a diffuse state in which the HVAC system 22 permits airflow to the foot well 14 via the concentrated duct lines 23 and the uniform duct lines 24.

The HVAC system 22 includes, inter alia, a conditioning duct 26 and a distribution duct or duct assembly 28. The conditioning duct 26 is fluidly coupled to the distribution duct 28 and includes a fan 30, a heating element 32 (e.g., a heater core or radiator) and/or a cooling element 33 (e.g., an air conditioning evaporator) disposed therein. The fan 30 is positioned upstream of the heating and cooling elements 32, 33. In some configurations, the fan 30 is positioned downstream of the heating and cooling elements 32, 33. The fan 30 draws air from outside of the vehicle 10 into the conditioning duct 26 and forces the air to flow through the conditioning duct 26 to the foot well 14. Airflow flowing through the conditioning duct 26 from outside the vehicle 10 is conditioned (e.g., heated, cool, etc.) by the heating element 32 or cooling element 33. For example, the heating element 32 or cooling element 33 is selectively activated to heat or cool the airflow passing through the conditioning duct 26 so that the airflow entering the foot well 14 from the conditioning duct 26 is at a desired temperature according to the occupant's comfort level.

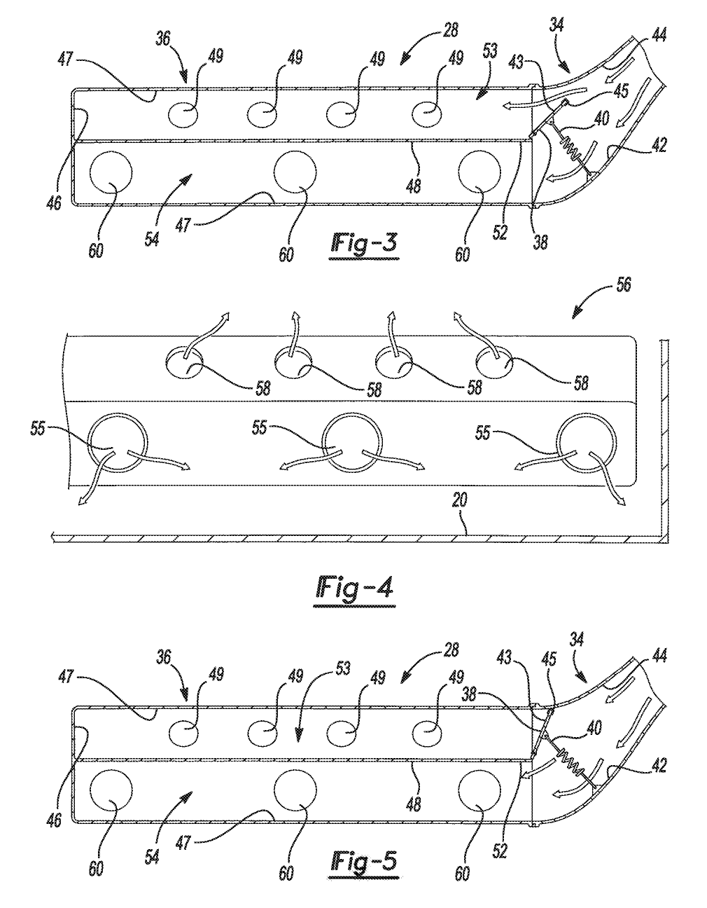

As shown in FIG. 1, the distribution duct 28 is positioned downstream of the conditioning duct 26 and is fluidly coupled to the foot well 14 via the concentrated duct lines 23 (only one shown in FIG. 1) and the uniform duct lines 24 (only one shown in FIG. 1). As shown in FIGS. 2-6, the distribution duct 28 includes an inlet passage 34 and a manifold 36. The inlet passage 34 is fluidly coupled to the manifold 36 and fluidly coupled to the conditioning duct 26. As shown in FIGS. 3 and 5, a door (i.e., a valve member) 38 is attached to and extends into the inlet passage 34. The door 38 is pivotally coupled to the manifold 36 to allow the door 38 to move between an open position (FIG. 3) and a closed position (FIG. 5).

A spring 40 is attached to an outer wall 42 of the inlet passage 34 and the door 38 and biases the door 38 toward the open position. A sufficiently strong flow of air (i.e., caused by a sufficiently high operating speed of the fan 30) through the inlet passage 34 may overcome the biasing force of the spring 40 and force the door 38 to move from the open position to the closed position. Once in the closed position, a distal end 43 of the door 38 abuts an inner wall 44 of the inlet passage 34. As shown in FIG. 5, a sealing member 45 is attached to the distal end 43 of the door 38 such that the sealing member 45 sealingly engages the inner wall 44 to create an airtight seal therebetween when the door 38 is in the closed position.

The manifold 36 includes a back wall 46, side walls 47, a partition member 48, uniform outlet openings 49, and direct outlet tubular protrusions 50. The partition member 48 is disposed between the side walls 47 and extends from the back wall 46 to the inlet passage 34 to divide the manifold 36 into a uniform outlet airflow path 53 and a direct outlet airflow path 54. The door 38 is pivotably mounted to the partition member 48 such that when the door 38 is in the closed position, air flowing through the inlet passage 34 can flow only into the direct outlet airflow path 54 and is prevented from flowing into the uniform outlet airflow path 53. When the door 38 is in the open position, a portion of the air flowing through the inlet passage 34 can flow through the uniform outlet airflow path 53 and another portion of the air flowing through the inlet passage 34 can flow through the direct outlet airflow path 54.

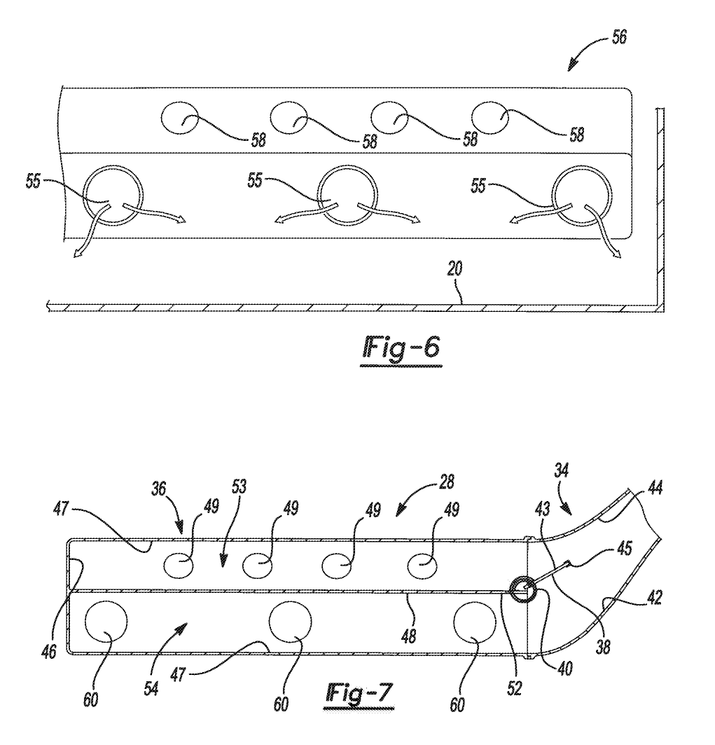

The uniform outlet openings 49 are equally spaced apart at the uniform outlet airflow path 53. Each opening 49 is fluidly coupled to an upstream end 25 of a corresponding uniform duct line 24 (FIG. 1). A downstream end 27 of each uniform duct line 24 is fluidly coupled with a corresponding one of a plurality of diffuse-flow apertures 58 (FIGS. 3 and 6) formed in an upper portion of a panel 56 (e.g., connected to or a part of the panel 11 shown in FIG. 1) within the foot well 14 of the occupant cabin 12. The diffuse-flow apertures 58 are also positioned above one or more concentrated-flow apertures 55 at the lower portion of the panel 56 within the foot well 14.

The direct outlet tubular protrusions 50 protrude outwardly from the manifold 36 (FIG. 2). Each protrusion 50 defines a direct outlet opening 60 in fluid communication with the direct outlet airflow path 54. Each protrusion 50 is coupled to an upstream end 29 of a corresponding concentrated duct line 23 such that each direct outlet opening 60 is in fluid communication with a corresponding one of the concentrated duct lines 23. A downstream end 21 of each concentrated duct line 23 is fluidly coupled with a corresponding one of the concentrated-flow aperture 55 (FIGS. 1, 4 and 6) formed in a lower portion of the panel 56 within the foot well 14 of the occupant cabin 12. The concentrated-flow apertures 55 within the foot well 14 are positioned above the vehicle floor 20 and are directed at or to an assumed position of occupant's legs, for example.

With continued reference to FIGS. 1-6, operation of the HVAC system 22 will be described in more detail below. As the occupant is seated in the vehicle seat assembly 16 (FIG. 1), each of the occupant's legs is disposed at a location within the foot well 14 that corresponds to the position of one or more of the concentrated-flow apertures 55 formed in the lower portion of the panel 56.

Upon entering the vehicle 10 and/or upon initially starting the vehicle 10, the occupant may increase the airflow through the HVAC system 22 adjusting a speed of the fan 30 to expedite achievement of the occupant's comfort level. For example, the occupant cabin 12 may be cold when the vehicle 10 is initially started and/or the occupant may be cold from being outdoors, and the occupant may desire an increase in the flow of heated air to his or her legs. Therefore, the occupant activates the heating element 32 within the conditioning duct 26 and increases the speed of the fan 30 so that the force of the airflow through the inlet passage 34 pushes against the door 38 with enough force to overcome the biasing force of the spring 40 and causes the door 38 to move from the open position (FIG. 3) to the closed positon (FIG. 5).

When the door 38 is in the closed position, the HVAC system 22 in the concentrated state and the airflow is directed to the direct outlet airflow path 54 and out the openings 60 in the protrusions 50. The airflow continues through the duct lines 23 and out the concentrated-flow apertures 55 formed in the lower portion of the panel 56 within the foot well 14 to the legs of the occupant, thereby, warming up the legs of the occupant.

Once the comfort level of the occupant's legs are achieved, the occupant may decrease the speed of the fan 30 to decrease the airflow through the HVAC system 22. This causes the force of the airflow to decrease and the door 38 is allowed to open so that the HVAC system 22 is in the diffuse state. Once in the diffuse state, the airflow is directed to both the uniform outlet airflow path 53 and the direct outlet airflow path 54 and out the openings 49, 60, respectively. The airflow continues through the concentrated duct lines 23 and the uniform duct lines 24 and out the apertures 55, 58, respectively. The airflow through the uniformly spaced apart openings 49 at the uniform outlet airflow path 53 maintains the foot well 14 temperature at the comfort level as determined by the occupant.

Blowing a concentrated flow of air on the occupant's legs using the concentrated mode will allow the occupant's legs to warm up faster than a diffused flow of air. The diffuse mode is good when the occupant is already warm because the air flow through the increased number of outlets allow a sufficient amount of heated air to enter the foot well 14 to keep the foot well 14 warm, without blowing a concentrated flow of heated air onto the occupant's legs. A concentrated flow of heated air onto the occupant's legs after the occupant's legs are already warms may cause the occupant to feel too warm, which may prompt the occupant to further lower or discontinue airflow to the foot well 14, which will cause the foot well 14 to eventually get too cold. Switching to the diffuse mode once the occupant's legs are cold allows sufficient warming of the foot well 14 without blowing a concentrated flow of air on the occupant's legs.

It should be understood that the HVAC system 22 can be switched between the diffuse state and the concentrated state at any time while the vehicle 10 is on. It should also be understood that the operation of the HVAC system 22 between the concentrated state and the diffuse state is the same if, for example, the occupant desires an increase in cooled airflow to the occupant's legs. Furthermore, while the panel 56 is described above as being positioned at the foot well 14 and the apertures 55, 58 are described above as providing airflow to the occupant's legs, it will be appreciated that the panel 56 and apertures 55, 58 could be positioned at any other location within the occupant cabin 12 to provide airflow to any other part of the occupant cabin 12 and/or to any other assumed location of any other portion of the occupant's body.

Furthermore, it should be understood that a particular range of speeds of the fan 30 (e.g., a range of speeds lower than a highest fan speed and higher than a lowest fan speed) will cause the door 38 to move a position between a fully open position and a fully closed position. As the door 38 is moved closer and closer to the fully closed position, less and less of the airflow through the HVAC system will be allowed to flow through the uniform outlet airflow path 53. Furthermore, it will be appreciated that the speed of the fan 30 could be adjusted manually, as described above, or the speed of the fan 30 could be automatically controlled based on the occupant's chosen temperature settings and an actual temperature within the occupant cabin 12. With reference to FIG. 7, another configuration of the distribution duct 28 is provided that includes a spring 140 instead of the spring 40. The structure and function of the distribution duct 28 with spring 140 is similar or identical to that of the distribution duct 28 with spring 40, apart from any exceptions described below.

The spring 140 is a thermal spring that is attached to the door 38 and the distribution duct 28. In the event that the airflow passing through the inlet passage 34 is lower than a threshold value, the thermal spring 140 contracts, thereby, gradually moving the door 38 toward the closed position. The sealing member 45 attached to the distal end 43 of the door 38 abuts the inner wall 44 to create an airtight seal that prevents airflow therethrough once the door 38 is actuated to the closed position. If the airflow passing through the inlet passage 34 exceeds the threshold value of the thermal spring 140, the thermal spring 140 expands, thereby, gradually moving the door 38 toward the open position. Therefore, the HVAC system 22 is operable between the concentrated state and the diffuse state as described above where the airflow to the uniform and direct outlet airflow paths 53, 54 is varied with the temperature.

What is claimed is:

1. A vehicle HVAC system delivering airflow to a vehicle occupant cabin, the vehicle HVAC system comprising:
a duct assembly including an inlet passage and a manifold receiving airflow from the inlet passage, the manifold including a uniform outlet airflow path, a direct outlet airflow path, and a valve member movable between an open position allowing air to flow from the inlet passage to the uniform outlet airflow path and a closed position allowing air to flow from the inlet passage to the direct outlet airflow path and restricting air from flowing from the inlet passage to the uniform outlet airflow path; and
a panel disposed in the vehicle occupant cabin and including a diffuse-flow aperture that is open to the vehicle occupant cabin and a concentrated-flow aperture that is open to the vehicle occupant cabin, the diffuse-flow aperture is fluidly connected to the uniform outlet airflow path and is fluidly isolated from the direct outlet airflow path, the concentrated-flow aperture is fluidly connected to the direct outlet airflow path and is fluidly isolated from the uniform outlet airflow path.

2. The vehicle HVAC system of claim 1, wherein the valve member allows air to flow from the inlet passage to the direct outlet airflow path when the valve member is in the open position.

3. The vehicle HVAC system of claim 2, wherein the duct assembly includes a partition that separates the uniform outlet airflow path and the direct outlet airflow path.

4. The vehicle HVAC system of claim 1, wherein a spring is attached to the valve member and biases the valve member toward the open position.

5. The vehicle HVAC system of claim 4, wherein the valve member is angled relative to the inlet passage such that air flowing through the inlet passage biases the valve member toward the closed position.

6. The vehicle HVAC system of claim 5, further comprising a fan disposed upstream of the manifold and forcing air through the inlet passage, the fan operable at a low speed and at a high speed, wherein the air flowing through the inlet passage when the fan is operating at the low speed exerts a lesser force on the valve member than a force that the spring exerts on the valve member biasing the valve member toward the open position, and wherein the air flowing through inlet passage when the fan is operating at the high speed exerts a greater force on the valve member biasing the valve member toward the closed position than the force that the spring exerts on the valve member biasing the valve member toward the open position.

7. The vehicle HVAC system of claim 6, wherein the valve member is pivotably mounted to the inlet passage of the duct assembly.

8. The vehicle HVAC system of claim 1, wherein a thermal spring is coupled to the valve member such that the valve member is moved to the closed position when a temperature of the airflow passing through the inlet passage exceeds a predetermined threshold value and the valve member is moved to the open position when the temperature of the airflow passing through the inlet passage is below the predetermined threshold value.

9. The vehicle HVAC system of claim 1, wherein the manifold includes a plurality of uniform outlet openings and a plurality of direct outlet openings, wherein air flowing though the uniform outlet airflow path exits the manifold through the uniform outlet openings, and wherein air flowing through the direct outlet airflow path exits the manifold through the direct outlet openings.

10. The vehicle HVAC system of claim 9, wherein the panel includes a plurality of diffuse-flow apertures and a plurality of concentrated-flow apertures.

11. The vehicle HVAC system of claim 10, further comprising a plurality of conduits connecting the manifold to the panel, wherein each of the uniform outlet openings is fluidly coupled with a corresponding one of the diffuse-flow apertures by a corresponding one of the plurality of conduits, and wherein each of the direct outlet openings is fluidly coupled with a corresponding one of the concentrated-flow apertures by a corresponding one of the plurality of conduits.

12. The vehicle HVAC system of claim 11, wherein the panel includes more diffuse-flow apertures than concentrated-flow apertures.

13. The vehicle HVAC system of claim 12, wherein the panel is disposed at a foot well within the vehicle occupant cabin, wherein the diffuse-flow aperture directs airflow into the foot well, and wherein the concentrated-flow aperture directs airflow into the foot well.

14. The vehicle HVAC system of claim 1, further comprising a heating element disposed upstream of the manifold and in a heat transfer relationship with airflow upstream of the manifold.

15. The vehicle HVAC system of claim 1, further comprising a cooling element disposed upstream of the manifold and in a heat transfer relationship with airflow upstream of the manifold.
